(19) United States
(12) Patent Application Publication
(10) Pub. No.: US 2012/0001761 A1
(43) Pub. Date: Jan. 5, 2012

(54) APPARATUS AND METHOD FOR DETECTING RADIATION

(75) Inventors: Martti Voutilainen, Espoo (FI); Pirjo Pasanen, Helsinki (FI)

(73) Assignee: NOKIA CORPORATION, Espoo (FI)

(21) Appl. No.: 12/828,479

(22) Filed: Jul. 1, 2010

(51) Int. Cl. G08B 17/12; G01T 1/20

(52) U.S. Cl. 340/600; 250/368; 250/362; 250/361 R

(57) ABSTRACT

In accordance with an example embodiment of the present invention, an apparatus is provided, including a scintillator configured to convert ionizing radiation into photons, and a photo detector including at least one graphene layer configured to detect said photons. In accordance with another example embodiment of the present invention, a method is provided, including receiving and detecting photons by a photo detector from a scintillator, said photo detector including at least one graphene layer configured to detect said photons, and transmitting information indicative of said detected photons from said apparatus to an external device.

### TECHNICAL FIELD

The present application relates generally to apparatuses and methods for detecting radiation.

### BACKGROUND

Ionizing radiation in the environment can be dangerous for living organisms. In order to protect people from potential hazards caused by careless or criminal handling of radioactive materials appropriate detectors for detecting ionizing radiation have been developed.

### SUMMARY

Various aspects of examples of the invention are set out in the claims.

According to a first aspect of the invention there is provided an apparatus, comprising:

a scintillator configured to convert ionizing radiation into photons; and
a photo detector comprising at least one graphene layer configured to detect said photons.

In an example embodiment, a detector detecting ionizing radiation is provided. In an example embodiment, the apparatus comprises an anti-reflecting layer separating said scintillator and said photo detector. In an example embodiment, the scintillator is formed by a layer of scintillating material.

In an example embodiment, a radiation detector for ionizing radiation combines a graphene photodetector with a scintillator. It combines the capability of graphene to work as a photodetector with a scintillation material that converts ionizing radiation, such as gamma or x-rays, into a cascade of visible light photons, which can then be detected using the graphene photodetector. In an example embodiment, the radiation detector comprises a scintillator foil overlaying a graphene sheet. In an example embodiment, the radiation detector comprises a graphene sheet of a few stacked layers of graphene. The radiation detector may comprise a graphene transistor or a plurality of graphene transistors. It may comprise multiple source and drain electrodes. More specifically, in an example embodiment, the apparatus comprises more than one source electrode and more than one drain electrode. In an example embodiment, said more than one source electrode and more than one drain electrode form an interdigitated pattern.

In an example embodiment, the apparatus comprises said scintillator on one side of said at least one graphene layer and a second scintillator on the other side of said at least one graphene layer.

In an example embodiment, the apparatus is configured to operate as a radiation detector using a self-biasing effect. In an example embodiment, by using the self-biasing effect the apparatus is configured to operate without a bias voltage. Accordingly, in an example embodiment, the apparatus is configured to operate as a radiation detector using a doping effect without a bias voltage.

In an example embodiment, the apparatus is configured to operate in a mode in which a bias voltage is used. Accordingly, in an example embodiment, the apparatus may be configured to operate either in a passive mode (without bias voltage) or in an active mode (with bias voltage) depending on the situation.

In an example embodiment, the apparatus is a handheld mobile communication device, such as a mobile phone. In other embodiments, the apparatus may be another device with radiation detection ability. Various embodiments of the invention may be directed to applications in various technical fields, including but not limited to medical, scientific and/or industrial applications.

According to a second aspect of the invention there is provided a method, comprising:

receiving and detecting photons by a photo detector of an apparatus from a scintillator of said apparatus, said photo detector comprising at least one graphene layer configured to detect said photons; and
transmitting information indicative of said detected photons from said apparatus to an external device.

In an example embodiment, the method comprises transmitting said information to said external device via a radio path. In an example embodiment, the method comprises transmitting said information to a remote surveillance and/or alert system. Such a system may be governed by an authority, such as a radiation and nuclear safety authority or similar.

According to a yet another aspect of the invention there is provided an apparatus, comprising:

conversion means configured to convert ionizing radiation into photons; and
detection means comprising at least one graphene layer configured to detect said photons.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well. Any appropriate combinations of the embodiments may be formed.

### BRIEF DESCRIPTION OF THE DRAWINGS

For a more complete understanding of example embodiments of the present invention, reference is now made to the following descriptions taken in connection with the accompanying drawings in which:

FIG. 1 shows a cross-section of a radiation detection apparatus in accordance with an example embodiment of the invention;

FIG. 2 shows a radiation detection module in accordance with an example embodiment of the invention;

FIG. 3 shows a cross-section of a radiation detection apparatus in accordance with another example embodiment of the invention;

FIG. 4 shows an example block diagram of an apparatus according to an example embodiment of the invention; and

FIG. 5 shows a flow diagram showing a method in accordance with an example embodiment of the invention.

### DETAILED DESCRIPTION

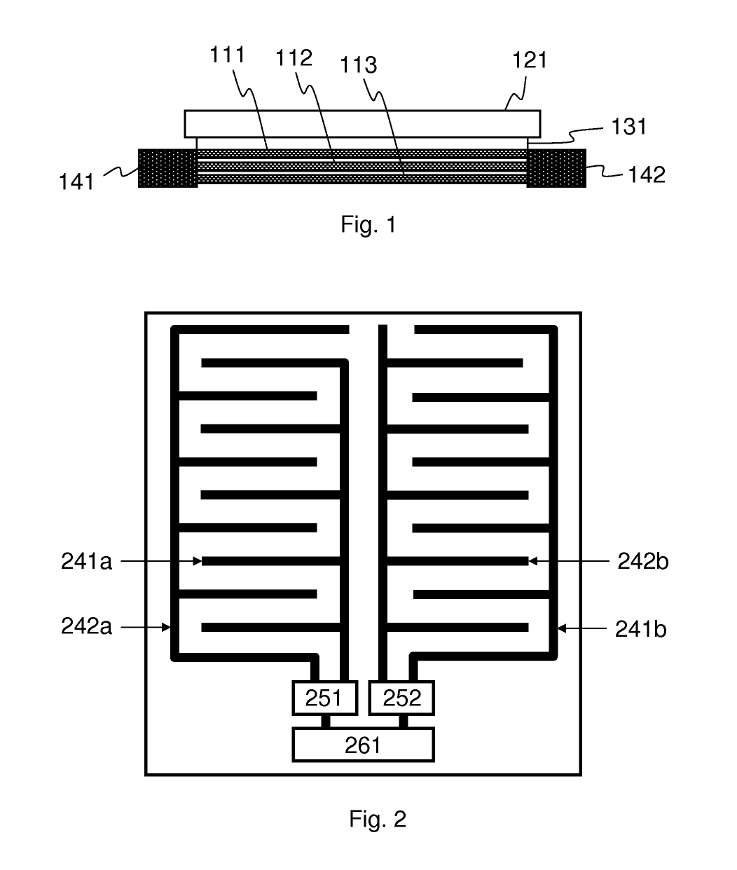

Example embodiments of the present invention and their potential advantages are understood by referring to FIGS. 1 through 5 of the drawings. In the following description, like numbers denote like elements.

Graphene absorbs photons effectively in visible, infrared and ultraviolet frequencies. The use of graphene as a photon detector is based on the observation that graphene absorbs light very evenly in the whole visible light spectrum. In certain example embodiments it has been further observed that by combining a graphene photo detector with a scintillator it is possible to use the photon detection ability of graphene to detect ionizing radiation.

FIG. 1 shows a cross-section of a radiation detection apparatus in accordance with an example embodiment of the invention. The radiation detection apparatus (or module) may form part of another device such as a handheld mobile communication device or another device.

The apparatus comprises a graphene sheet connected to source 141 and drain 142 electrodes. The graphene sheet comprises at least one graphene layer. Depending on the embodiment, the number of graphene layers may vary. In the example embodiment shown in FIG. 1, three graphene layers 111-113 are visible.

The graphene layers can be fabricated on top of each other with a suitable fabrication method to form a few-layer graphene sheet. Suitable fabrication methods include for example CVD (chemical vapor deposition), exfoliation from graphite, or sublimation for example from SiC surfaces. A support or substrate (not shown) may be used onto which the graphene layers are grown. The support or substrate may be of dielectric material such as for example SiO₂ or a polymer.

The electrodes 141-142 may be of metal and can be fabricated by standard lithography methods. Their mutual distance may be for example around 500 nm.

On top of the graphene sheet is placed a scintillator 121. It may be a foil or layer made of any suitable scintillation material that converts ionizing radiation, such as gamma or x-rays, into visible light photons which are then received and sensed by the graphene sheet of the detector. In other words, as to the operation of the apparatus in an example embodiment, the photon detection capability of graphene is used to detect ionizing radiation, such as x-rays and/or gamma-rays. First the energy of the ionizing radiation is converted into photons in visible frequency range by using the scintillator 121 and then the generated photons are detected by using the graphene sheet of the detector.

Suitable scintillation materials are for example NaI(Tl), CsI(Tl), and many other materials including also polymeric materials. A typical thickness of the scintillator 121 is less than 1 mm.

In an example embodiment, to avoid reflections, the apparatus may comprise an anti-reflecting layer between the scintillator 121 and the graphene sheet (represented by layers 111-113). Alternatively, or in addition, the surface of the scintillator 121 can be covered from graphene side by a thin photon reflection prevention layer to enable maximum light transmission from scintillator to graphene and from other sides by photon reflection layers to reflect all created light towards the graphene photon detector.

FIG. 2 shows a radiation detection module in more detail in accordance with an example embodiment of the invention. The radiation detection module may be composed of a few-layer graphene sheet similarly as in the example embodiment shown in FIG. 1, and source and drain electrodes connected to a differential transimpedance (or transconductance) amplifier. In the example embodiment shown in FIG. 2, there are shown two pairs of source and drain electrodes. The first pair shown comprises the source electrode 241a and the drain electrode 242a. The second pair comprises the source electrode 241b and the drain electrode 242b. The electrodes can be formed as an interdigitated pattern such as shown in FIG. 2.

A differential transimpedance (or transconductance) amplifier is for measuring current from photon-generated electrons and holes near source and drain electrodes. A differential transimpedance (or transconductance) amplifier can be for every source and drain ribbon to measure current generated by individual radiation events (e.g., gamma-ray events, etc.) or for a network of source and drain ribbons to measure current generated by several radiation events. In the example embodiment shown in FIG. 2, the source and drain electrodes 241a and 242a are connected to a first differential transimpedance (or transconductance) amplifier 251. The source and drain electrodes 241b and 242b are connected to a second differential transimpedance (or transconductance) amplifier 252, respectively.

A logic part 261 is connected to the amplifiers 251-252 to make conclusions based on the measured signal (or current). In an example embodiment, information concerning the measured signal (indicative of said detected photons) is transmitted to a device external to the device in which the radiation detection apparatus resides. In addition to sending information indicative of said detected photons, positioning information of the device can be transmitted in the same transmission. Information indicative of said detected photons can be transmitted via a radio path, for example via cellular data communication. If for example the level of the measured signal exceeds a limit, an alarm is in an example embodiment sent to an authority.

If for example the signal from radiation such as gamma or x-ray radiation is measured and the level exceeds a typical level of radiation occurring from natural sources, an alarm may be transmitted using cellular data communication to radiation safety authorities. The authorities collect the information, and if for example high radiation levels are received from several mobile phones in the same location, the authorities can take appropriate action. They can, for example, send a radiation detection specialist to analyze the reason for a high radiation level in more detail, or broadcast a general alarm.

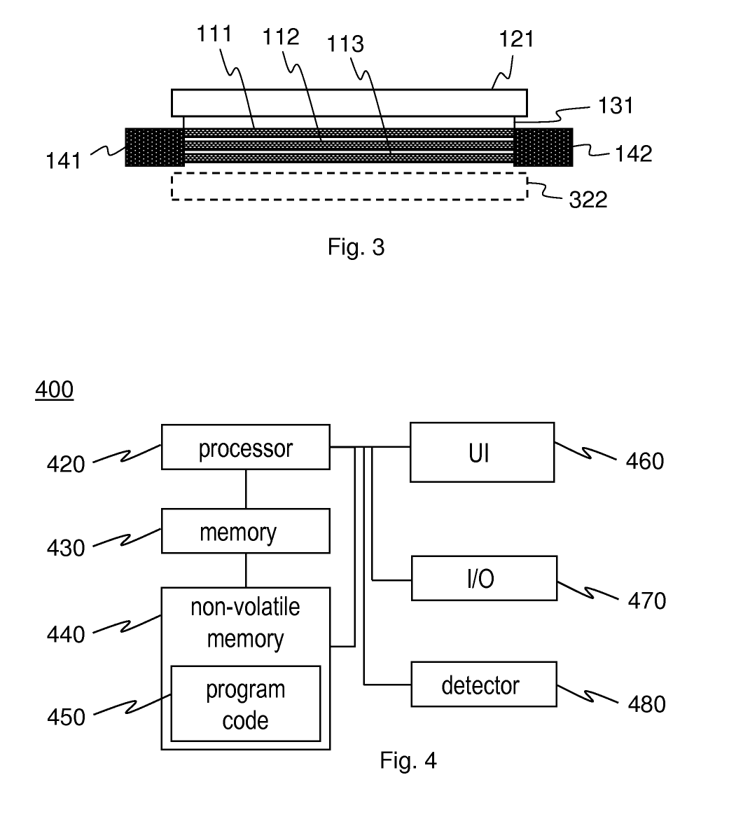

FIG. 3 shows a cross-section of a radiation detection apparatus in accordance with another example embodiment of the invention. In this embodiment, instead of one scintillator, the apparatus comprises two scintillators. The photon sensing graphene layers 111-113 are sandwiched from both sides from scintillators. The construction comprises the scintillator 121 positioned similarly as is the example embodiment shown in FIG. 1 and a second scintillator 322 on the other side of the graphene layers 111-113. The position of the second scintillator 322 is illustrated by dotted lines in FIG. 3.

In further embodiments, it is possible to have even more scintillators. In another example embodiment, photon detection layers and more than two scintillators can be stacked to form a multi-layered structure. Alternatively, or in addition, each scintillator may have a plurality of layers.

In an example embodiment, the graphene photo detector may use a self-biasing effect. It may be properly biased by doping effects of the electrodes so that external biasing is not needed (“zero-bias operation”). Graphene near the source and drain electrodes may be biased to P-type and N-type by using source and drain electrode metal for doping. Using only the doping effect of the metal contacts, enhanced with chemical doping if appropriate, does not require any bias voltage.

In practice, it is possible to practically eliminate a leakage current by using zero or very small source-drain voltage. Then, the potential difference generated by a doping effect of the source and drain metal contacts is used to drive the photon generated electrons and holes to source and drain electrodes for further amplification. In a further example embodiment, the zero-bias operation can be enhanced by choosing the metal contacts so that the doping effect is enhanced, that is, by choosing different metals to source and drain electrodes, with different work functions.

Alternatively, or in addition, electrical doping can be used. Namely, by applying a bias voltage, the detection efficiency can be enhanced. Accordingly, in an example embodiment, the apparatus may be configured to operate either in a passive mode (without bias voltage) or in an active mode (with bias voltage) depending on the situation.

In an alternative example embodiment, by powering the radiation detection part (or module) only for short periods of a few second intervals and by keeping part continuously powered on only if radiation level is above a pre-defined threshold, average power consumption can be kept lower.

FIG. 4 shows an example block diagram of an apparatus 400 according to an example embodiment of the invention.

The apparatus 400 comprises at least one non-volatile memory 440 configured to store computer programs or software comprising computer program code 450. The apparatus 400 further comprises at least one processor 420 for controlling the operation of the apparatus 400 using the computer program code 450, a work memory 430 for running the computer program code 450 by the at least one processor 420, and optionally an input/output system 470 for communicating with other apparatuses or external devices. Accordingly, the input/output system 470, if present, comprises one or more communication units or modules providing communication interfaces towards a communication network and/or towards external devices. The apparatus 400 comprises a user interface 460 enabling a user to use the device.

The apparatus 400 further comprises a radiation detection apparatus or module discussed in the example embodiments (hereinafter referred to as detector 480). The detector 480 is connected to the at least one processor 420. It may be controlled by the at least one processor 420. Instead or in addition, the detector 480 may comprise its own processor controlling its operation or the operation of the whole apparatus 400. Depending on whether the apparatus is a mobile communication device housing a detector, or, for example, a mere detector device, the structure of the apparatus may deviate from that presented in FIG. 4. One or more of the blocks may be omitted and/or one or more additional blocks may be added in an actual implementation.

In the detector 480 occurs the generation of photons based on received ionizing radiation, and the detection of the generated photons as described in the foregoing. Information indicative of said detected photons (and positioning information) can be transmitted to an external device via the input/output system 470. A value representing ionizing radiation can be obtained from the detector 480 and can be shown to the user on the user interface 460. An indication of exceeding a pre-defined limit can be indicated on the user device with sound and/or visible feedback. These and other operations can be controlled by the at least one processor 420 based on the computer program code 450.

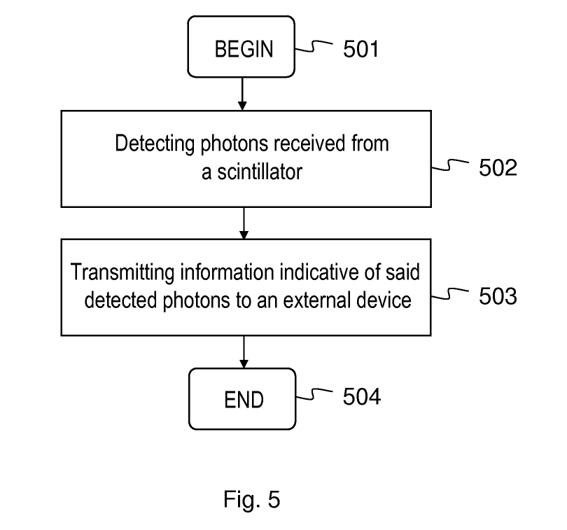

FIG. 5 is a flow diagram showing a method in accordance with an example embodiment of the invention. The method begins in block 501. In block 502, photons are received and detected by a photo detector of an apparatus from a scintillator of said apparatus, said photo detector comprising at least one graphene layer configured to detect said photons. In an example embodiment, the photons have been generated by the scintillator and represent the amount of ionizing radiation received by the scintillator. In block 503, information indicative of said detected photons is transmitted from said apparatus to an external device, for example to a device operated by an authority. The method ends in block 504.

Without in any way limiting the scope, interpretation, or application of the claims appearing below, certain technical effects of one or more of the example embodiments disclosed herein are listed in the following: A technical effect is a low-cost instrument for detecting ionizing radiation such as gamma-ray radiation or x-ray radiation. Another technical effect is a low-power radiation detection method that can be used in a personal radiation safety device and as part of a radiation alarm system to protect citizens on harmful radioactive materials. A further technical effect is to provide a dense detector network when placing detectors into mobile phones. It is possible to receive real time response to protect people from potential hazards caused by careless or criminal handling of radioactive materials.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

If desired, the different functions discussed herein may be performed in a different order and/or concurrently with each other. Furthermore, if desired, one or more of the above-described functions may be optional.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. An apparatus, comprising:
a scintillator configured to convert ionizing radiation into photons; and
a photo detector comprising at least one graphene layer configured to detect said photons.

2. An apparatus according to claim 1, comprising an anti-reflecting layer separating said scintillator and said photo detector.

3. An apparatus according to claim 1, comprising more than one source electrode and more than one drain electrode.

4. An apparatus according to claim 3, comprising said more than one source electrode and more than one drain electrode in an interdigitated pattern.

5. An apparatus according to claim 1, comprising said scintillator on one side of said at least one graphene layer and a second scintillator on the other side of said at least one graphene layer.

6. An apparatus according to claim 1, wherein the apparatus is configured to operate as a radiation detector using a self-biasing effect.

7. An apparatus according to claim 6, wherein the apparatus is configured to operate in a mode in which a bias voltage is used.

8. An apparatus according to claim 1, wherein the apparatus is a handheld mobile communication device.

9. A method, comprising:
receiving and detecting photons by a photo detector of an apparatus from a scintillator of said apparatus, said photo detector comprising at least one graphene layer configured to detect said photons; and
transmitting information indicative of said detected photons from said apparatus to an external device.

10. A method according to claim 9, comprising:
transmitting said information to said external device via a radio path.

11. A method according to claim 9, comprising:
transmitting said information to a remote surveillance and alert system.
